(19) United States
(12) Patent Application Publication
(10) Pub. No.: US 2020/0317196 A1
(43) Pub. Date: Oct. 8, 2020

(54) VEHICLE CONTROL SYSTEM, VEHICLE CONTROL METHOD AND VEHICLE CONTROL PROGRAM

(71) Applicant: HONDA MOTOR CO., LTD., Minato-ku (JP)

(72) Inventors: Mineyuki Yoshida, Wako-shi (JP); Yoshihiro Oniwa, Wako-shi (JP); Hiroshi Oguro, Wako-shi (JP)

(21) Appl. No.: 16/305,103

(22) PCT Filed: May 12, 2017
(86) PCT No.: PCT/JP2017/018007

§ 371 Date: Nov. 28, 2018

(30) Foreign Application Priority Data
May 31, 2016 (JP) 2016-108528

(51) Int. Cl. B60W 30/18; G05D 1/02; B60W 60/00; B60W 10/20

(52) U.S. Cl. CPC B60W 30/181; G05D 1/0212; B60W 2510/20; B60W 10/20; B60W 2520/06; B60W 60/001

(57) ABSTRACT

A vehicle control system includes a trajectory generation unit configured to generate a target trajectory of a vehicle, a determination unit configured to determine whether or not the vehicle is about to stop on the basis of the target trajectory generated by the trajectory generation unit, and a post-stop target trajectory generation unit configured to generate a post-stop target trajectory after the vehicle stops on the basis of the target trajectory before the vehicle stops in a case where it is determined that the vehicle is about to stop by the determination unit.

### TECHNICAL FIELD

The present invention relates to a vehicle control system, a vehicle control method, and a vehicle control program.

Priority is claimed on Japanese Patent Application No. 2016-108528, filed May 31, 2016, the content of which is incorporated herein by reference.

### BACKGROUND ART

In recent years, research has progressed on a technique (hereinafter, referred to as automatic driving) for controlling a vehicle such that it automatically travels along a route to a destination (for example, refer to Patent Literature 1).

### CITATION LIST

### Patent Literature

[Patent Literature 1]

Japanese Unexamined Patent Application, First Publication No. 2015-157604

### SUMMARY OF INVENTION

### Technical Problem

However, in the related art, when a vehicle stops in a state in which the vehicle was traveling with a certain steering angle and then the vehicle starts, the vehicle may not be able to start with an appropriate steering angle in some cases.

An aspect according to the present invention has been made in consideration of such circumstances, and an object of the present invention is to provide a vehicle control system, a vehicle control method, and a vehicle control program capable of appropriately controlling a steering angle when a vehicle starts after the vehicle stops.

### Solution to Problem

(1) A vehicle control system according to an aspect of the present invention includes a trajectory generation unit configured to generate a target trajectory of a vehicle, a determination unit configured to determine whether or not the vehicle is about to stop on the basis of the target trajectory generated by the trajectory generation unit, and a post-stop target trajectory generation unit configured to generate a post-stop target trajectory after the vehicle stops on the basis of the target trajectory before the vehicle stops in a case where it is determined that the vehicle is about to stop by the determination unit.

(2) In the aspect of the above-described (1), the vehicle control system may further include a traveling control unit configured to derive a steering angle of the vehicle in a state in which the vehicle stops on the basis of the post-stop target trajectory generated by the post-stop target trajectory generation unit and control a steering device on the basis of the derived steering angle.

(3) In the aspect of the above-described (2), the traveling control unit may derive the steering angle of the vehicle at a time when the vehicle stops before the vehicle stops on the basis of the post-stop target trajectory generated by the post-stop target trajectory generation unit and control the steering device on the basis of the derived steering angle.

(4) In the aspect of any one of the above-described (1) to (3), the determination unit may determine whether or not the vehicle is about to stop on the basis of part of information on the target trajectory of the vehicle generated by the trajectory generation unit.

(5) In the aspect of any one of the above-described (1) to (4), the vehicle control system may further include a first storage unit configured to accumulate information on the target trajectory of the vehicle generated by the trajectory generation unit and overwrite the target trajectory of the vehicle on the basis of the accumulated state, and a second storage unit configured to store the information on the target trajectory. In a case where the determination unit determines that the vehicle is about to stop, the determination unit may store part of the information on the target trajectory of the vehicle accumulated in the first storage unit into the second storage unit.

(6) In the aspect of the above-described (5), in a case where it is determined that the vehicle is about to stop by the determination unit, the post-stop target trajectory generation unit may generate the post-stop target trajectory after the vehicle stops on the basis of the information on the target trajectory stored in the second storage unit.

(7) A vehicle control system according to an aspect of the present invention includes a first trajectory generation unit configured to generate a target trajectory of a vehicle as a position of the vehicle at each sampling time, a determination unit configured to acquire the target trajectory of the vehicle generated by the first trajectory generation unit and determines whether or not the position of the vehicle is in an unchanged state for a predetermined time on the basis of the position of the vehicle at each sampling time included in the acquired target trajectory, and a second trajectory generation unit configured to generate the target trajectory of the vehicle at a time after a position determined as the unchanged state on the basis of the position of the vehicle at a time before the position determined as the unchanged state in a case where it is determined that the position of the vehicle is in the unchanged state for the predetermined time by the determination unit.

(8) A vehicle control method according to an aspect of the present invention causes an in-vehicle computer to generate a target trajectory of a vehicle, determine whether or not the vehicle is about to stop on the basis of the generated target trajectory, and generate a post-stop target trajectory after the vehicle stops on the basis of the target trajectory before the vehicle stops in a case where it is determined that the vehicle is about to stop.

(9) A vehicle control program according to an aspect of the present invention causes an in-vehicle computer to generate a target trajectory of a vehicle, determine whether or not the vehicle is about to stop on the basis of the generated target trajectory, and generate a post-stop target trajectory after the vehicle stops on the basis of the target trajectory before the vehicle stops in a case where it is determined that the vehicle is about to stop.

### Advantageous Effects of Invention

According to the above-described (1), (2), (4), and (7) to (9), in a case where it is predicted that the vehicle is about to stop by the determination unit, the post-stop target trajectory after the vehicle stops is generated on the basis of the target trajectory before the vehicle stops. In addition, it is possible to appropriately control a steering angle when the vehicle starts after the vehicle stops by deriving the steering angle on the basis of the post-stop target trajectory.

According to the above-described (3), a subject vehicle M is able to smoothly start traveling by controlling steering on the basis of the derived steering angle before the vehicle stops.

According to the above-described (5) and (6), in a case where it is predicted that the vehicle is about to stop, the determination unit stores the part of the information on the target trajectory of the vehicle generated by the trajectory generation unit in the second storage unit. Therefore, it is possible to decrease the load of an own device.

### BRIEF DESCRIPTION OF DRAWINGS

FIG. 1 is a diagram illustrating constitution elements of a vehicle on which a vehicle control system of each embodiment is mounted.

FIG. 2 is a functional constitution diagram centered on the vehicle control system according to the first embodiment.

FIG. 3 is a diagram illustrating an aspect in which a relative position of a subject vehicle with respect to a traveling lane is recognized by a subject vehicle position recognition unit.

FIG. 4 is a diagram illustrating an example of an action plan generated for a certain section.

FIG. 5 is a diagram illustrating an example of a constitution of a trajectory generation unit.

FIG. 6 is a diagram illustrating an example of a candidate for a trajectory generated by a trajectory candidate generation unit.

FIG. 7 is a diagram expressing the candidates for the trajectory generated by the trajectory candidate generation unit by trajectory points K.

FIG. 8 is a diagram illustrating a lane change target position.

FIG. 9 is a diagram illustrating a speed generation model in a case where it is assumed that speeds of three surrounding vehicles are constant.

FIG. 10 is a diagram illustrating a relationship between an acceleration or deceleration control unit, a steering angle control unit, and a control target thereof.

FIG. 11 is a diagram illustrating an example of a function of the steering angle control unit.

FIG. 12 is a conceptual diagram of control executed in a case where it is predicted that the subject vehicle will stop.

FIG. 13 is a diagram for explaining processing of deriving a steering angle by a first steering angle deriving unit.

FIG. 14 is a conceptual diagram illustrating a derivation of a second steering angle by a second steering angle deriving unit.

FIG. 15 is a flowchart illustrating a flow of processing executed by the steering angle control unit.

FIG. 16 is a diagram for explaining processing of a determination unit.

FIG. 17 is a diagram for explaining processing of generating a fitting trajectory.

FIG. 18 is a diagram for explaining processing of deriving a gaze position.

FIG. 19 is a diagram illustrating an example of an aspect in which the subject vehicle is controlled by the processing of the present embodiment.

FIG. 20 is a diagram illustrating an example of a function of a steering angle control unit of a second embodiment.

FIG. 21 is a flowchart illustrating a flow of processing executed by the steering angle control unit.

### DESCRIPTION OF EMBODIMENTS

Hereinafter, embodiments of a vehicle control system, a vehicle control method, and a vehicle control program of the present invention will be described with reference to the drawings.

### First Embodiment

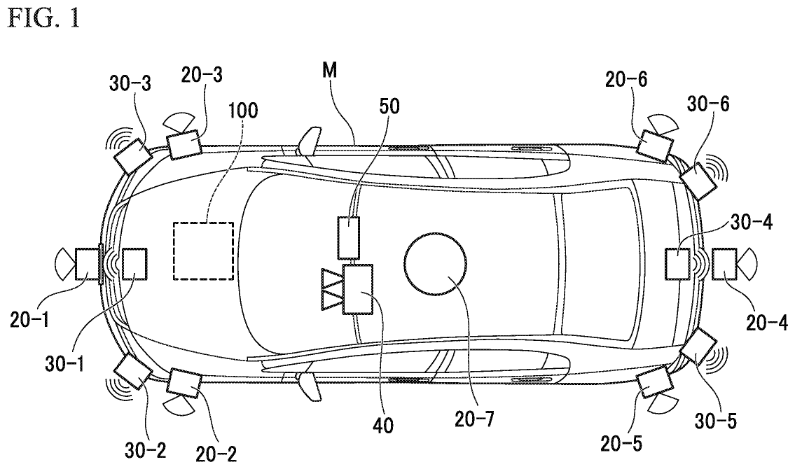

FIG. 1 is a diagram illustrating constitution elements of a vehicle (hereinafter, referred to as a subject vehicle M) on which a vehicle control system 100 of each embodiment is mounted. For example, the vehicle on which the vehicle control system 100 is mounted is a vehicle such as a two-wheeled vehicle, a three-wheeled vehicle, or four-wheeled vehicle, and includes a vehicle using an internal combustion engine such as a diesel engine or a gasoline engine as a power source, an electric vehicle using an electric motor as a power source, a hybrid vehicle including an internal combustion engine and an electric motor, and the like. For example, the electric vehicle is driven using electric power discharged by a battery such as a secondary battery, a hydrogen fuel cell, a metal fuel cell, and an alcohol fuel cell.

As shown in FIG. 1, sensors such as viewfinders 20-1 to 20-7, radars 30-1 to 30-6, a camera 40, a navigation device 50 (a route guidance device), and the vehicle control system 100 are mounted on the subject vehicle M.

For example, the viewfinders 20-1 to 20-7 are light detection and ranging or laser imaging detection and ranging (LIDAR) that measures scattered light with respect to irradiation light and measures a distance to an object. For example, the viewfinder 20-1 is attached to a front grille or the like, and the viewfinders 20-2 and 20-3 are attached to a side surface of a vehicle body, a door mirror, a headlight inside, in the vicinity of a side lamp, or the like. The viewfinder 20-4 is attached to a trunk lid or the like, and the viewfinders 20-5 and 20-6 are attached to the side surface of the vehicle body, a taillight inside, or the like. For example, the viewfinders 20-1 to 20-6 described above have a detection region of about 150 degrees with respect to a horizontal direction. In addition, the viewfinder 20-7 is attached to a roof or the like.

For example, the viewfinder 20-7 has a detection region of 360 degrees with respect to the horizontal direction. For example, the radars 30-1 and 30-4 are long distance millimeter wave radars of which the detection region in a depth direction is wider than other radars. In addition, the radars 30-2, 30-3, 30-5, and 30-6 are intermediate distance millimeter wave radars of which the detection region in a depth direction is narrower than the radars 30-1 and 30-4.

Hereinafter, the viewfinders 20-1 to 20-7 are simply referred to as “viewfinder 20” in a case where the viewfinders 20-1 to 20-7 are not particularly distinguished from each other, and the radars 30-1 to 30-6 are simply referred to as “radar 30” in a case where the radars 30-1 to 30-6 are not particularly distinguished from each other. For example, the radar 30 detects an object by a frequency modulated continuous wave (FM-CW) method.

For example, the camera 40 is a digital camera using a solid state imaging device such as a charge coupled device (CCD) or a complementary metal oxide semiconductor (CMOS). The camera 40 is attached to an upper portion of a front windshield, a rear surface of the room mirror, or the like. For example, the camera 40 periodically repeats imaging of in front of the subject vehicle M. The camera 40 may be a stereo camera including a plurality of cameras.

It is noted that the constitution shown in FIG. 1 is merely an example, and part of the constitution may be omitted or other constitutions may be added.

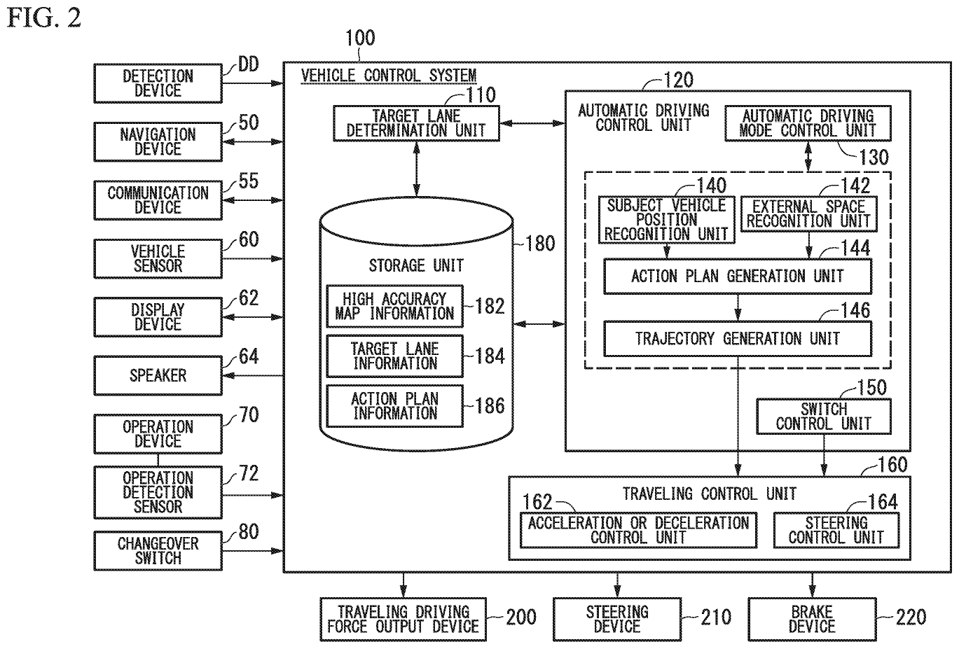

FIG. 2 is a functional constitution diagram centered on the vehicle control system 100 according to the first embodiment. A detection device DD including the viewfinder 20, the radar 30, the camera 40, and the like, the navigation device 50, a communication device 55, a vehicle sensor 60, a display device 62, a speaker 64, a switch unit 66, an operation device 70, an operation detection sensor 72, a changeover switch 80, the vehicle control system 100, a traveling driving force output device 200, a steering device 210, and a brake device 220 are mounted on the subject vehicle M. Such devices and apparatuses are connected with each other by a multiplex communication line such as a controller area network (CAN) communication line, a serial communication line, a wireless communication network, or the like. It is noted that the vehicle control system 100 and the above-described constitutions (such as the detection device DD) other than the vehicle control system 100 may be referred to as the vehicle control system in some cases.

The navigation device 50 includes a global navigation satellite system (GNSS) receiver, map information (a navigation map), a touch panel type display device functioning as a user interface, a speaker, a microphone, and the like. The navigation device 50 specifies a position of the subject vehicle M by the GNSS receiver and derives a route from the position to a destination designated by a user. The route derived by the navigation device 50 is provided to a target lane determination unit 110 of the vehicle control system 100. The position of the subject vehicle M may be specified or supplemented by an inertial navigation system (INS) using an output of the vehicle sensor 60. In addition, when the vehicle control system 100 is executing a manual driving mode, the navigation device 50 performs guidance by sound or a navigation display regarding the route to the destination. It is noted that the constitution for specifying the position of the subject vehicle M may be provided independently from the navigation device 50. In addition, for example, the navigation device 50 may be realized by a function of a terminal device such as a smartphone or a tablet terminal possessed by the user. In this case, transmission and reception of information is performed between the terminal device and the vehicle control system 100 by wireless or wired communication.

For example, the communication device 55 performs wireless communication using a cellular network, a Wi-Fi network, Bluetooth (registered trademark), dedicated short range communication (DSRC), or the like.

The vehicle sensor 60 includes a vehicle speed sensor that detects a vehicle speed, an acceleration sensor that detects acceleration, a yaw rate sensor that detects an angular velocity around a vertical axis, a direction sensor that detects a direction of the subject vehicle M, and the like.

The display device 62 displays the information as an image. For example, the display device 62 includes a liquid crystal display (LCD), an organic electroluminescence (EL) display device, or the like. In the present embodiment, it is assumed that the display device 62 is a head up display that reflects an image on the front window of the subject vehicle M and displays the image in a field of view of a vehicle occupant. It is noted that the display device 62 may be a display device included in the navigation device 50 or a display device of an instrument panel for displaying a state (speed or the like) of the subject vehicle M. The speaker 64 outputs the information as a sound.

For example, the operation device 70 includes an acceleration pedal, a steering wheel, a brake pedal, a shift lever, and the like. An operation detection sensor 72 for detecting the presence or absence and an amount of operation by a driver is attached to the operation device 70. For example, the operation detection sensor 72 includes an accelerator opening degree sensor, a steering torque sensor, a brake sensor, a shift position sensor, and the like. The operation detection sensor 72 outputs an accelerator opening degree, a steering torque, a brake depression amount, a shift position, and the like as a detection result to a traveling control unit 160. In addition, instead of this, the detection result of the operation detection sensor 72 may be directly output to the traveling driving force output device 200, the steering device 210, or the brake device 220.

The changeover switch 80 is a switch operated by a driver or the like. The changeover switch 80 receives the operation of the driver or the like, generates a control mode designation signal for designating a control mode by the traveling control unit 160 as any one of an automatic driving mode or a manual driving mode, and outputs the control mode designation signal to a switch control unit 150. As described above, the automatic driving mode is a driving mode in which the traveling is performed in a state in which the driver does not perform operations (or an operation amount is smaller than that of the manual driving mode or an operation frequency is lower than that of the manual driving mode). More specifically, the automatic driving mode is a driving mode for controlling part or all of the traveling driving force output device 200, the steering device 210, and the brake device 220 on the basis of an action plan. In addition, the changeover switch 80 may receive various operations in addition to the operation of switching the automatic driving mode.

Before describing the vehicle control system 100, the traveling driving force output device 200, the steering device 210, and the brake device 220 will be described.

The traveling driving force output device 200 outputs a traveling driving force (torque) for enabling the vehicle to travel to driving wheels. For example, in a case where the subject vehicle M is a vehicle using an internal combustion engine as a power source, the traveling driving force output device 200 includes an engine, a transmission and engine electronic control unit (ECU) that controls the engine. In a case where the subject vehicle M is an electric vehicle using an electric motor as a power source, the traveling driving force output device 200 includes a traveling motor and a motor ECU that controls the traveling motor. In a case where the subject vehicle M is a hybrid vehicle, the traveling driving force output device 200 includes an engine, a transmission, an engine ECU, a traveling motor, and the motor ECU. In a case where the traveling driving force output device 200 includes only the engine, the engine ECU adjusts a throttle opening degree of the engine, a shift stage, or the like according to information input from the traveling control unit 160 that will be described later. In a case where the traveling driving force output device 200 includes only the traveling motor, the motor ECU adjusts a duty ratio of a PWM signal to be supplied to the traveling motor according to the information input from the traveling control unit 160. In a case where the traveling driving force output device 200 includes the engine and the traveling motor, the engine ECU and the motor ECU cooperate with each other to control the traveling driving force according to the information input from the traveling control unit 160.

For example, the steering device 210 includes a steering ECU and an electric motor.

For example, the electric motor changes a direction of steerable wheels by applying a force to a rack and pinion mechanism. The steering ECU drives the electric motor according to information input from the vehicle control system 100 or information on an input steering angle or steering torque and changes the direction of the steerable wheels.

For example, the brake device 220 is an electric servo brake device including a brake caliper, a cylinder that transfers hydraulic pressure to the brake caliper, an electric motor that generates the hydraulic pressure in the cylinder, and a brake control unit. The brake control unit of the electric servo brake device controls the electric motor according to the information input from the traveling control unit 160 and outputs the brake torque corresponding to the brake operation to each wheel. The electric servo brake device may include a mechanism that transfers the hydraulic pressure generated by an operation of the brake pedal to the cylinder through a master cylinder as a backup. It is noted that the brake device 220 is not limited to the above-described electric servo brake device but may be an electronically controlled hydraulic brake device. The electronically controlled hydraulic brake device controls an actuator according to the information input from the traveling control unit 160 and transfers the hydraulic pressure of the master cylinder to the cylinder. In addition, the brake device 220 may include a regenerative brake by the traveling motor that may be included in the traveling driving force output device 200.

[Vehicle Control System]

Hereinafter, the vehicle control system 100 will be described. For example, the vehicle control system 100 is realized by one or more processors or hardware having an equivalent function. The vehicle control system 100 may have a constitution in which an electronic control unit (ECU) in which a processor such as a CPU, a storage device, and a communication interface are connected with each other by an internal bus, a micro-processing unit (MPU), or the like is combined.

Returning to FIG. 2, for example, the vehicle control system 100 includes the target lane determination unit 110, an automatic driving control unit 120, the traveling control unit 160, and a storage unit 180. For example, the automatic driving control unit 120 includes an automatic driving mode control unit 130, a subject vehicle position recognition unit 140, an external space recognition unit 142, an action plan generation unit 144, a trajectory generation unit 146, and the switch control unit 150. Part or all of the target lane determination unit 110, each unit of the automatic driving control unit 120, and the traveling control unit 160 are realized by a processor executing a program (software). In addition, part or all of these may be realized by hardware such as a large scale integration (LSI) or an application specific integrated circuit (ASIC) or may be realized by a combination of software and hardware.

For example, the storage unit 180 stores information such as high accuracy map information 182, target lane information 184, and action plan information 186. The storage unit 180 is realized by a read only memory (ROM), a random access memory (RAM), a hard disk drive (HDD), a flash memory, or the like. The program executed by the processor may be stored in the storage unit 180 in advance or may be downloaded from an external device through an in-vehicle Internet facility or the like. In addition, the program may be installed in the storage unit 180 when a portable storage medium storing the program is mounted in a drive device that is not shown. In addition, the vehicle control system 100 may be distributed by a plurality of computer devices.

For example, the target lane determination unit 110 is realized by the MPU. The target lane determination unit 110 divides the route provided from the navigation device 50 into a plurality of blocks (for example, divides the route every 100 [m] with respect to the vehicle traveling direction) and determines a target lane for each block with reference to the high accuracy map information 182. For example, the target lane determination unit 110 determines which lane from the left the vehicle will travel on. For example, in a case where a branching position, a merging position, or the like is present on the route, the target lane determination unit 110 determines the target lane so that the subject vehicle M may travel on a reasonable traveling route for progressing to a branch destination. The target lane determined by the target lane determination unit 110 is stored in the storage unit 180 as the target lane information 184.

The high accuracy map information 182 is map information with an accuracy higher than a navigation map included in the navigation device 50. For example, the high accuracy map information 182 includes information on the center of a lane, information on a boundary of a lane, and the like. In addition, the high accuracy map information 182 may include road information, traffic regulations information, address information (an address and a postal code), facility information, telephone number information, and the like. The road information includes information indicating a type of a road such as an expressway, a toll road, a national highway, a prefectural road, or information on the number of lanes on the road, the width of each lane, a gradient of the road, the position of the road (three-dimensional coordinates including the longitude, the latitude, and the height), the curvature of a curve of a lane, the positions of junction and branch points of a lane, a sign provided on the road, and the like. The traffic regulations information includes information that lanes are blocked due to roadwork, a traffic accident, traffic congestion, or the like.

The automatic driving mode control unit 130 determines a mode of the automatic driving executed by the automatic driving control unit 120. The mode of the automatic driving in the present embodiment includes the following modes. It is noted that the following are merely examples, and the number and type of the mode of the automatic driving may be arbitrarily determined.

[Mode A]

The mode A is a mode of which a degree of the automatic driving is the highest. In a case where the mode A is being executed, all vehicle controls such as complicated merging control are automatically performed, the vehicle occupant does not need to monitor surroundings or state of the subject vehicle M.

[Mode B]

The mode B is a mode of which a degree of the automatic driving is high next to the mode A. In a case where the mode B is being executed, in principle, all vehicle controls are automatically performed, but the driving operation of the subject vehicle M is entrusted to the vehicle occupant according to a situation. Therefore, the vehicle occupant needs to monitor the surroundings or state of the subject vehicle M.

[Mode C]

The mode C is a mode of which a degree of the automatic driving is high next to the mode B. In a case where the mode C is being executed, the vehicle occupant needs to perform a confirmation operation on the changeover switch 80 according to the situation. For example, in the mode C, in a case where a timing of a lane change is notified to the vehicle occupant and the vehicle occupant performs an operation for instructing the changeover switch 80 to change the lane, an automatic lane change is performed. Therefore, the vehicle occupant needs to monitor the surroundings or state of the subject vehicle M.

The automatic driving mode control unit 130 determines the mode of the automatic driving on the basis of the operation of the vehicle occupant with respect to the changeover switch 80, an event determined by the action plan generation unit 144, a traveling aspect determined by the trajectory generation unit 146, and the like. A limit according to performance or the like of the detection device DD of the subject vehicle M may be set in the mode of the automatic driving. For example, in a case where the performance of the detection device DD is low, the mode A may not be performed. In any mode, it is possible to switch (override) to the manual driving mode by an operation for a constitution of a driving operation system in the changeover switch 80.

The subject vehicle position recognition unit 140 of the automatic driving control unit 120 recognizes a lane (a traveling lane) on which the subject vehicle M is traveling and a relative position of the subject vehicle M with respect to the traveling lane on the basis of the high accuracy map information 182 stored in the storage unit 180, and the information input from the viewfinder 20, the radar 30, the camera 40, the navigation device 50, or the vehicle sensor 60.

For example, the subject vehicle position recognition unit 140 may recognize the traveling lane by comparing a pattern of road lane line (for example, an arrangement of solid lines and broken lines) recognized from the high accuracy map information 182 with a pattern of a road lane line of the surroundings of the subject vehicle M recognized from the image captured by the camera 40.

In the recognition, the position of the subject vehicle M acquired from the navigation device 50 or the process result by the INS may be included.

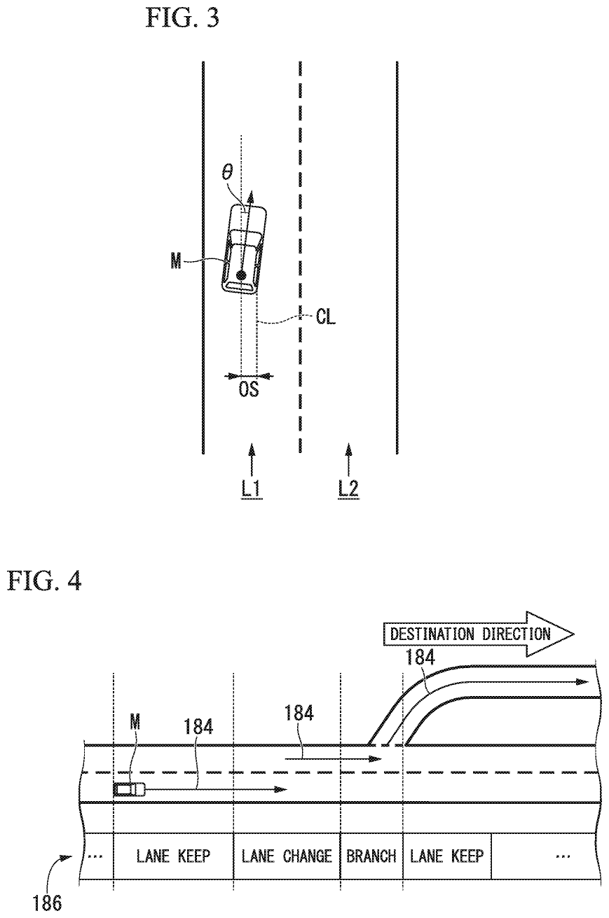

FIG. 3 is a diagram illustrating an aspect in which the relative position of the subject vehicle M with respect to a traveling lane L1 is recognized by the subject vehicle position recognition unit 140. For example, the subject vehicle position recognition unit 140 recognizes a deviation OS from a traveling lane center CL of a reference point (for example, a center of gravity) of the subject vehicle M and an angle θ formed with respect to a line connecting the traveling lane center CL of a direction of travel of the subject vehicle M, as the relative position of the subject vehicle M with respect to the traveling lane L1. In addition, instead of this, the subject vehicle position recognition unit 140 may recognize the position or the like of the reference point of the subject vehicle M with respect to one of side ends of the traveling lane L1 as the relative position of the subject vehicle M with respect to the traveling lane. The relative position of the subject vehicle M recognized by the subject vehicle position recognition unit 140 is provided to the target lane determination unit 110.

The external space recognition unit 142 recognizes a state such as the position, the speed, and the acceleration of a surrounding vehicle, on the basis of the information input from the viewfinder 20, the radar 30, the camera 40, and the like. For example, the surrounding vehicle is a vehicle traveling around the subject vehicle M and traveling in the same direction as the subject vehicle M. The position of the surrounding vehicle may be indicated by a representative point such as a center of gravity or a corner of the surrounding vehicle or may be indicated by a region expressed by an outline of another vehicle. The “state” of the surrounding vehicle may include an acceleration of the surrounding vehicle or whether or not the surrounding vehicle is changing a lane (or whether or not the surrounding vehicle is trying to change the lane) grasped on the basis of the information of the above-described various devices. In addition, the external space recognition unit 142 may recognize positions of a guardrail, a utility pole, a parked vehicle, a pedestrian, and other objects in addition to the surrounding vehicle.

The action plan generation unit 144 sets a start point of the automatic driving and/or a destination of the automatic driving. The start point of the automatic driving may be a current position of the subject vehicle M or may be a point where the operation for instructing the automatic driving is performed. The action plan generation unit 144 generates an action plan in a section between the start point and the destination of the automatic driving. It is noted that the present invention is not limited thereto, and the action plan generation unit 144 may generate the action plan for an arbitrary section.

For example, the action plan includes a plurality of events that are sequentially executed. For example, the event includes a deceleration event for decelerating the subject vehicle M, an acceleration event for accelerating the subject vehicle M, a lane keep event for causing the subject vehicle M to travel so as not to deviate from the traveling lane, a lane change event for changing the traveling lane, an overtaking event for causing the subject vehicle M to overtake a preceding vehicle, a branch event for changing the subject vehicle M to a desired lane or causing the subject vehicle M to travel so as not to deviate from the current traveling lane at a branch point, a merge event for causing the subject vehicle M to accelerate or decelerate and changing the traveling lane in the merge lane for merging the subject vehicle M to a main lane, a handover event for shifting the mode from the manual driving mode to the automatic driving mode at the start point of the automatic driving or shifting the mode from the automatic driving mode to the manual driving mode at the end scheduled point of the automatic driving, and the like. The action plan generation unit 144 sets the lane change event, the branch event, or the merge event at a place where the target lane determined by the target lane determination unit 110 switches. Information indicating the action plan generated by the action plan generation unit 144 is stored in the storage unit 180 as the action plan information 186.

FIG. 4 is a diagram illustrating an example of the action plan generated for a certain section. As shown in the drawing, the action plan generation unit 144 generates the action plan necessary for the subject vehicle M to travel on the target lane indicated by the target lane information 184. It is noted that the action plan generation unit 144 may dynamically change the action plan regardless of the target lane information 184 according to a situation change of the subject vehicle M. For example, in a case where the speed of the surrounding vehicle recognized by the external space recognition unit 142 during the vehicle traveling is greater than a threshold value or a movement direction of the surrounding vehicle traveling in a lane adjacent to the subject lane faces toward the subject lane, the action plan generation unit 144 changes the event set in a driving section where the subject vehicle M is scheduled to travel. For example, in a case where the event is set so that the lane change event is executed after the lane keep event, the action plan generation unit 144 may change an event next to the lane keep event from the lane change event to the deceleration event, the lane keep event, or the like in a case where it is determined that a vehicle proceeds at a speed equal to or greater than the threshold value from behind a lane of a lane change destination during the lane keep event by the recognition result of the external space recognition unit 142. As a result, the vehicle control system 100 can cause the subject vehicle M to automatically travel safely even in a case where a change occurs in a state of an external space.

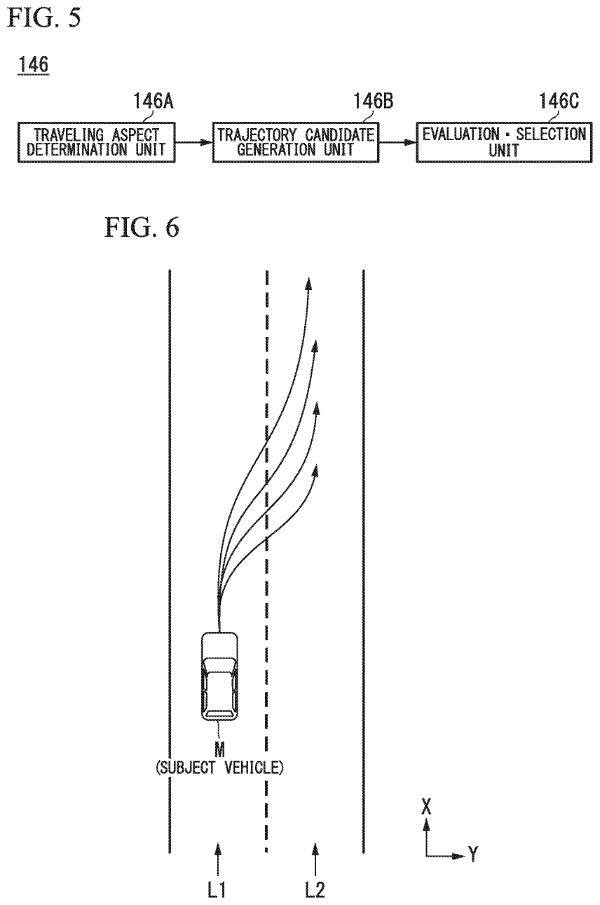

FIG. 5 is a diagram illustrating an example of a constitution of the trajectory generation unit 146. For example, the trajectory generation unit 146 includes a traveling aspect determination unit 146A, a trajectory candidate generation unit 146B, and an evaluation⋅selection unit 146C.

For example, when the lane keep event is executed, the traveling aspect determination unit 146A determines one of traveling aspects among constant speed traveling, following traveling, low speed following traveling, deceleration traveling, curve traveling, obstacle avoidance traveling, and the like. In this case, in a case where other vehicles are not present in front of the subject vehicle M, the traveling aspect determination unit 146A determines a traveling aspect as the constant speed traveling. In addition, in a case where following the preceding vehicle is performed, the traveling aspect determination unit 146A determines the traveling aspect as the following traveling. In addition, in a congestion situation or the like, the traveling aspect determination unit 146A determines the traveling aspect as the low speed following traveling. In addition, in a case where a deceleration of the preceding vehicle is recognized by the external space recognition unit 142 or in a case where an event of stopping, parking, or the like is implemented, the traveling aspect determination unit 146A determines the traveling aspect as the deceleration traveling. In addition, in a case where it is recognized that the subject vehicle M reaches a curve road by the external space recognition unit 142, the traveling aspect determination unit 146A determines the traveling aspect as the curve traveling. In addition, in a case where an obstacle is recognized in front of the subject vehicle M by the external space recognition unit 142, the traveling aspect determination unit 146A determines the traveling aspect as the obstacle avoidance traveling. In addition, in a case where the lane change event, the overtaking event, the branch event, the merge event, the handover event, and the like are implemented, the traveling aspect determination unit 146A determines the traveling aspect according to each event.

The trajectory candidate generation unit 146B generates a candidate for the trajectory on the basis of the traveling aspect determined by the traveling aspect determination unit 146A. FIG. 6 is a diagram illustrating an example of the candidate for the trajectory generated by the trajectory candidate generation unit 146B. FIG. 6 shows a candidate for a trajectory generated in a case where the subject vehicle M changes the lane from a lane L1 to a lane L2.

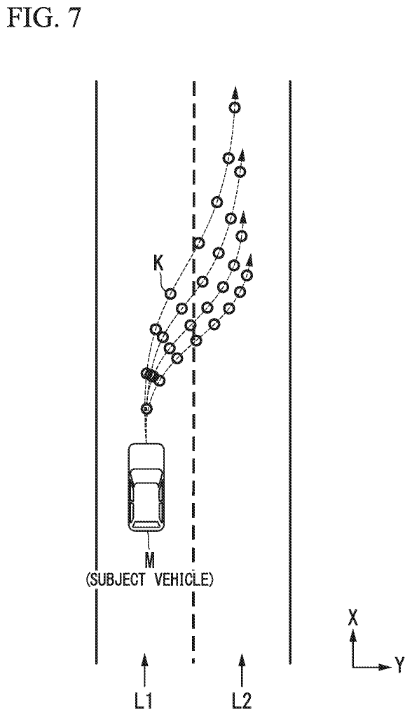

For example, the trajectory candidate generation unit 146B determines a trajectory as shown in FIG. 6 as a collection of target trajectory points (trajectory point K) which a predetermined position (for example, a center of gravity or a rear wheel shaft center) on the subject vehicle M reaches, at predetermined time intervals in the future. FIG. 7 is a diagram expressing the candidate for the trajectory generated by the trajectory candidate generation unit 146B by the trajectory points K. As a distance between the trajectory points K becomes wider, the speed of the subject vehicle M becomes greater, and as the distance between the trajectory points K is narrower, the speed of the subject vehicle M becomes slower. Therefore, in a case of performing the acceleration, the trajectory candidate generation unit 146B gradually widens the distance between the trajectory points K, and in a case of performing the deceleration, the trajectory candidate generation unit 146B gradually narrows the distance between the trajectory points K.

As described above, since the trajectory point K includes a speed component, the trajectory candidate generation unit 146B needs to give a target speed to each of the trajectory points K. The target speed is determined according to the traveling aspect determined by the traveling aspect determination unit 146A.

Here, a method of determining the target speed in a case where the lane change (including a branch) is performed will be described.

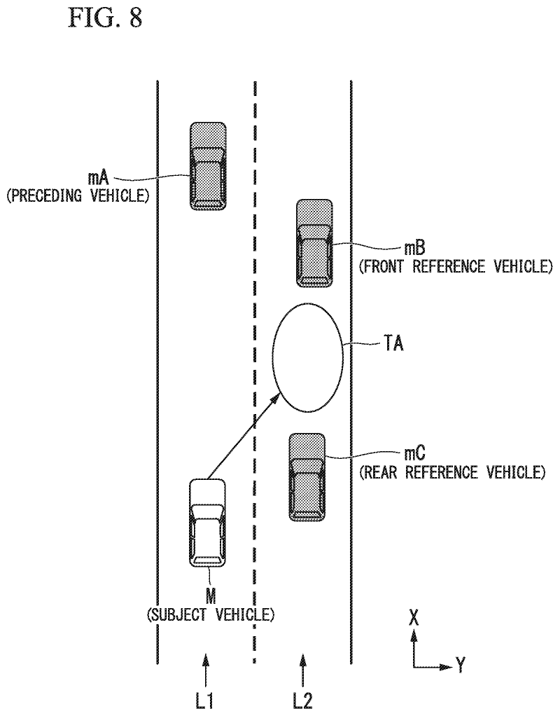

First, the trajectory candidate generation unit 146B sets a lane change target position (or a merge target position). The lane change target position is set as a relative position with respect to the surrounding vehicle and determines “which surrounding vehicles to change lanes between”. The trajectory candidate generation unit 146B focuses on three surrounding vehicles on the basis of the lane change target position and determines the target speed in a case where the lane change is performed. FIG. 8 is a diagram illustrating a lane change target position TA.

In the drawing, L1 denotes the subject lane and L2 denotes an adjacent lane. Here, on the same lane as the subject vehicle M, a surrounding vehicle that travels immediately before the subject vehicle M will be referred to as a preceding vehicle mA, a surrounding vehicle that travels immediately before the lane change target position TA will be referred to as a front reference vehicle mB, and a surrounding vehicle that travels immediately after the lane change target position TA will be referred to as a rear reference vehicle mC. The subject vehicle M needs to accelerate or decelerate in order to move to a side of the lane change target position TA, but it is necessary to avoid catching up with the preceding vehicle mA at this time. Therefore, the trajectory candidate generation unit 146B predicts a future state of the three surrounding vehicles and determines the target speed so as not to interfere with each surrounding vehicles.

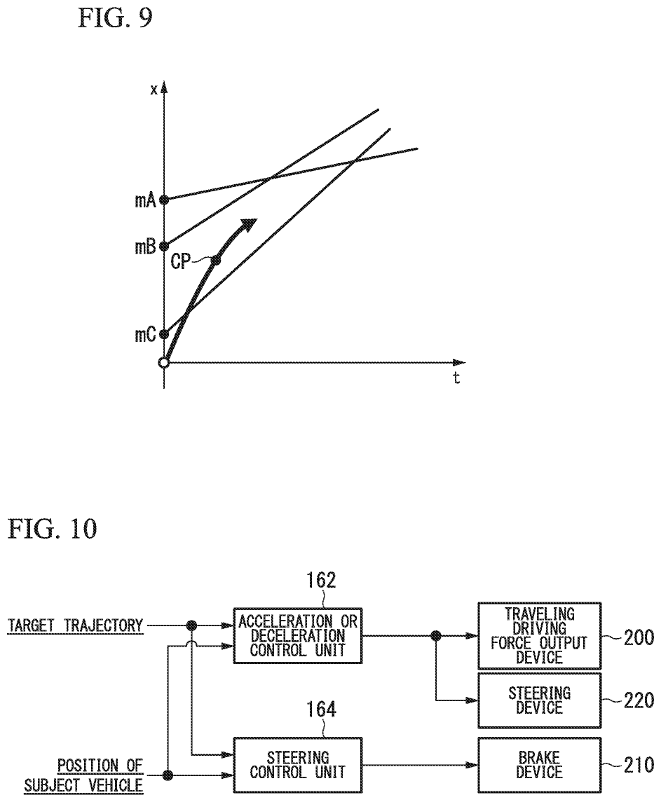

FIG. 9 is a diagram illustrating a speed generation model in a case where it is assumed that speeds of the three surrounding vehicles are constant. In the drawing, a straight line extending from mA, mB, and mC indicates a displacement in a traveling direction of a case where it is assumed that each surrounding vehicle travels at a constant speed. The subject vehicle M is required to be present between the front reference vehicle mB and the rear reference vehicle mC at a point CP where the lane change is completed and is required to be present behind the preceding vehicle mA before the subject vehicle M is present between the front reference vehicle mB and the rear reference vehicle mC. Under such restriction, the trajectory candidate generation unit 146B derives a plurality of time series patterns of the target speed until the lane change is completed. In addition, a plurality of trajectory candidates as shown in FIG. 7 are derived by applying the time series patterns of the target speed to a model such as a spline curve. It is noted that motion patterns of the three surrounding vehicles are not limited to the constant speed as shown in FIG. 9, but may be predicted on a premise of a constant acceleration and a constant jerk (jerk).

For example, the evaluation⋅selection unit 146C evaluates the candidate for the trajectory generated by the trajectory candidate generation unit 146B from two viewpoints of planning quality and safety and selects the target trajectory to be output to the traveling control unit 160. For example, from the viewpoint of the planning quality, in a case where conformance to an already generated plan (for example, the action plan) is high and a total length of the trajectory is short, the trajectory is highly evaluated. For example, in a case where it is desired to perform the lane change in a rightward direction, a trajectory in which temporary lane change is performed to a left direction and the subject vehicle is returned is lowly evaluated. From the viewpoint of the safety, for example, at each trajectory point, when a distance between the subject vehicle M and the object (the surrounding vehicle or the like) is long and the acceleration or deceleration speed or a change amount of the steering angle is small, the trajectory is highly evaluated.

The switch control unit 150 switches between the automatic driving mode and the manual driving mode on the basis of a signal input from the changeover switch 80. In addition, the switch control unit 150 switches the mode from the automatic driving mode to the manual driving mode on the basis of the operation instructing the acceleration, the deceleration, or the steering to the operation device 70. For example, in a case where a state in which an operation amount indicated by the signal input from the operation device 70 is greater than a threshold value continues for a time equal to or greater than a reference time, the switch control unit 150 switches (overrides) the mode from the automatic driving mode to the manual driving mode. In addition, in a case where an operation of the operation device 70 has not been detected for a predetermined time after switching to the manual driving mode by overriding, the switch control unit 150 may cause return to the automatic driving mode.

For example, as shown in FIG. 2, the traveling control unit 160 includes an acceleration or deceleration control unit 162 and a steering angle control unit 164. The traveling control unit 160 controls the traveling driving force output device 200, the steering device 210, and the brake device 220 so that the subject vehicle M passes along the trajectory generated by the trajectory candidate generation unit 146B according to a scheduled time (a time associated with the trajectory point). It addition, in the present embodiment, the steering angle control unit 164 is described as part of the traveling control unit 160, but the steering angle control unit 164 may be part of the trajectory generation unit 146.

FIG. 10 is a diagram illustrating a relationship between the acceleration or deceleration control unit 162, the steering angle control unit 164, and a control target thereof. The acceleration or deceleration control unit 162 and the steering angle control unit 164 are provided with the target trajectory from the trajectory generation unit 146 in the automatic driving control unit 120 and are provided with the position of the subject vehicle specified by the navigation device 50 and the subject vehicle position recognition unit 140. The acceleration or deceleration control unit 162 controls the traveling driving force output device 200 and the brake device 220 on the basis of the target trajectory acquired by the automatic driving control unit 120 and the position of the subject vehicle M. The steering angle control unit 164 controls the steering device 210 on the basis of the target trajectory acquired by the automatic driving control unit 120 and the position of the subject vehicle M.

[Function of Steering Angle Control Unit]

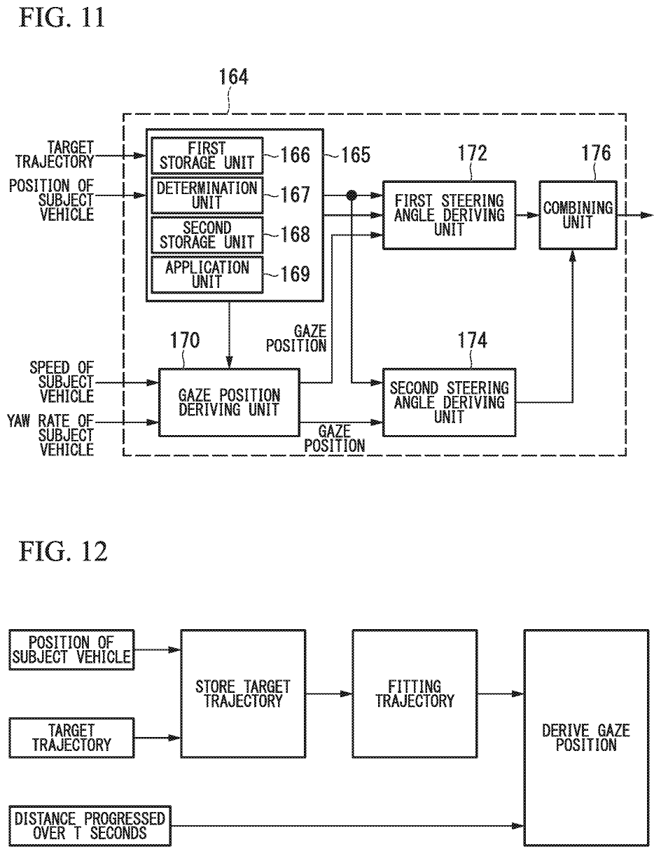

FIG. 11 is a diagram illustrating an example of the function of the steering angle control unit 164. For example, the steering angle control unit 164 includes a processing unit 165, a gaze position deriving unit 170, a first steering angle deriving unit 172, a second steering angle deriving unit 174, and a combining unit 176.

The processing unit 165 includes a first storage unit 166, a determination unit 167, a second storage unit 168, and an application unit 169 (a post-stop target trajectory generation unit).

In the first storage unit 166, information on the target trajectory output from the automatic driving control unit 120 and information on the position of the subject vehicle M are stored under control of the processing unit 165. For example, the first storage unit 166 is a buffer in which information is temporarily stored. For example, the first storage unit 166 includes an interface for communicating with the automatic driving control unit 120 and a storage device such as a RAM. The information on the target trajectory output from the automatic driving control unit 120 is part of information on the target trajectory generated by the automatic driving control unit 120. For example, in a case where a target trajectory (for example, for nine seconds) is generated by the automatic driving control unit 120, the part is information on a target trajectory (for example, for three seconds) which is less than this.

For example, the information on the target trajectory generated for each processing period of the trajectory generation unit 146 is stored in the first storage unit 166. For example, in a case where a new target trajectory different from the existing target trajectory is acquired, the processing unit 165 accumulates information on the newly acquired target trajectory in the first storage unit 166 by overwriting the information on the existing target trajectory with the information on the newly acquired target trajectory to. For example, in a case where a target trajectory generated in a next processing period is acquired from the automatic driving control unit 120, the processing unit 165 discards a stored target trajectory of a previous processing period and stores the newly acquired target trajectory of the processing period in the first storage unit 166.

For example, the first storage unit 166 stores information on a target trajectory of which a total length is equal to or greater than a predetermined length (for example, 3 m) and in which the speed of the subject vehicle M instructed by the automatic driving control unit 120 is equal to or greater than a predetermined speed (for example, 2 m/s).

For example, in a case where information of a target trajectory that does not correspond to the above-described conditions is acquired, the processing unit 165 does not store the target trajectory in a storage region of the first storage unit 166. For example, a target trajectory that does not correspond to the above-described conditions is a target trajectory immediately before the subject vehicle M stops. In this case, the subsequent processing is executed on the basis of the target trajectory of the previous processing period stored in the storage region.

The determination unit 167 predicts whether or not the subject vehicle M will stop (determines whether or not the subject vehicle M is about to stop) on the basis of the target trajectory stored in the storage region of the first storage unit 166. In a case where it is predicted that the subject vehicle M will stop, the determination unit 167 stores the information stored in the storage region of the first storage unit 166 in the second storage unit 168. The second storage unit 168 has a storage region in which information is stored. For example, the information stored in the first storage unit 166 is removed and stored in the second storage unit 168, before the information stored in the first storage unit 166 is overwritten with other pieces of information. For example, the second storage unit 168 includes a storage device such as a RAM.

The application unit 169 generates a fitting trajectory (the post-stop target trajectory) using the information stored in the second storage unit 168 and the nth degree function. “n” is an arbitrary natural number. The fitting trajectory is a trajectory generated in a case where it is predicted that the subject vehicle M will stop by the determination unit 167 and is a trajectory assuming that the subject vehicle M travels in a case where the subject vehicle M restarts traveling after the subject vehicle M stops. Details will be described later.

The gaze position deriving unit 170 derives a gaze position. FIG. 12 is a conceptual diagram of control executed in a case where it is predicted that the subject vehicle M will stop. As described above, in a case where it is predicted that the subject vehicle M will stop, the gaze position deriving unit 170 derives the gaze position on the fitting trajectory generated by the application unit 169. On the other hand, in a case where it is not predicted that the subject vehicle M will stop, the gaze position deriving unit 170 derives the gaze position on the target trajectory.

The first steering angle deriving unit 172 controls the steering of the subject vehicle M on the basis of a virtual circular arc having a tangent line along a progress direction of the subject vehicle M and passing through the gaze position and the position of the subject vehicle M. Here, the progress direction of the subject vehicle M may be a direction of a center axis of the vehicle or may be a direction in which a speed vector of the subject vehicle M at that moment is directed.

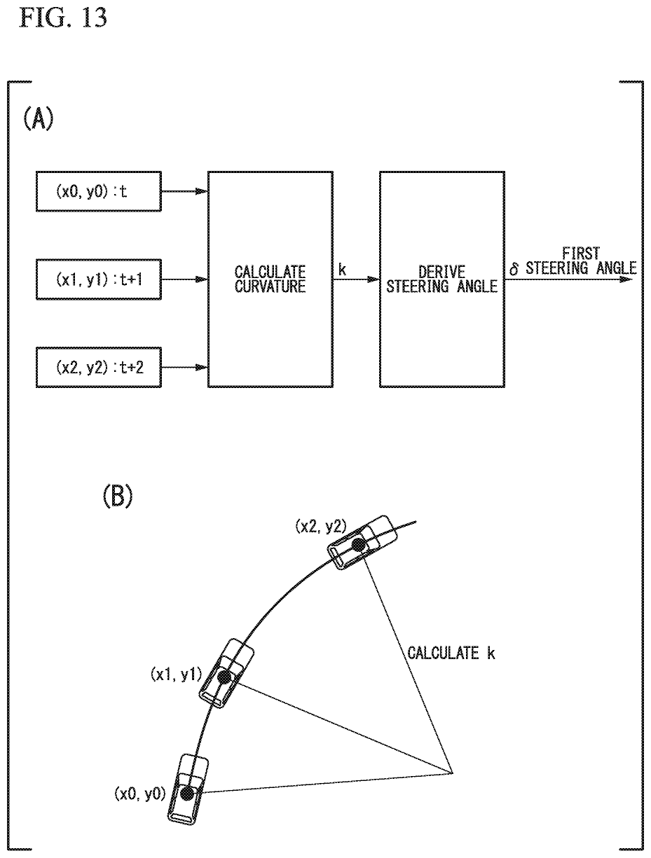

FIG. 13 is a diagram for explaining processing of deriving of the steering angle by the first steering angle deriving unit 172. FIG. 13(A) shows a flow of the deriving processing of the first steering angle and FIG. 13(B) shows a transition of the position of the subject vehicle. The first steering angle deriving unit 172 assumes that the subject vehicle M turns around a predetermined steady circle. For example, the steady circle is a turning trajectory in a case where the traveling is performed in a state in which a steering wheel turns in a certain turning angle.

For example, in the target trajectory, the first steering angle deriving unit 172 derives the position of the subject vehicle M at a time t (the current position; x0, y0), the position of the subject vehicle M at a time t+1 (x1, y1), and the position of the subject vehicle M at a time t+2 (x2, y2). For example, one of the positions of the subject vehicle M at the time t+1 and the time t+2 is the gaze position derived by the gaze position deriving unit 170. The first steering angle deriving unit 172 derives a curvature of the steady circle under an assumption that the subject vehicle M turns around a steady circle passing through the above-described three points at a certain time. The first steering angle deriving unit 172 derives the steering angle of the subject vehicle M on the basis of the following equation (1) under the assumption that the subject vehicle M turns around the steady circuit in a steady state. In the following equation (1), δ is a steering wheel angle, k is the curvature of the steady circle, A is a stability factor, V is a vehicle speed, L is a wheel base, and n is a gear ratio. For example, the steering angle is indicated by an absolute value, and the same is applied to the following description.

δ=k×(1+A×V²)×L×n (1)

It addition, in the target trajectory, the first steering angle deriving unit 172 may derive the curvature using the position of the subject vehicle M at the time t (the current position; x0, y0), the position of the subject vehicle M at a time t−1 (−x1, −y1), and the steady circle passing through the gaze position.

In addition, in a case where the curvature of the circular arc is greater than a predetermined value, the first steering angle deriving unit 172 may restrict the control of the steering of the subject vehicle M by correcting the curvature of the circular arc such that it is equal to or less than a predetermined value. The circular arc is part of a circumference of the steady circle.

The second steering angle deriving unit 174 derives a second steering angle that increases the controlled steering of the own vehicle M as a deviation between the gaze position in a direction orthogonal to the progress direction of the subject vehicle M and the position of the subject vehicle M increases.

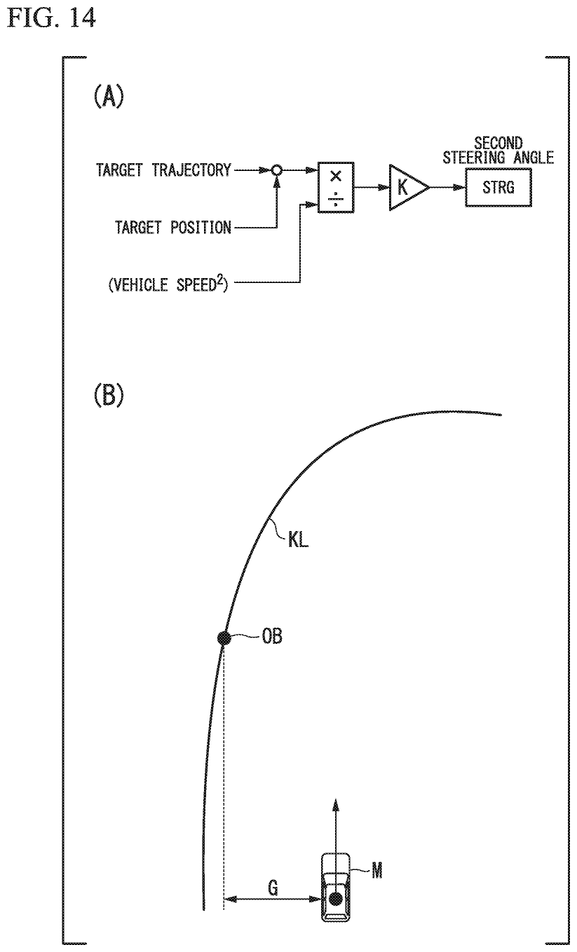

FIG. 14 is a conceptual diagram illustrating a derivation of the second steering angle by the second steering angle deriving unit 174.

FIG. 14(A) shows a flow of deriving processing of the second steering angle and FIG. 14(B) shows an aspect in which the second steering angle is derived. The second steering angle deriving unit 174 derives a lateral deviation G between a gaze position OP on a target trajectory KL in the direction orthogonal to the progress direction of the subject vehicle M and the position of the subject vehicle M. The gaze position OP is a position where the subject vehicle M is present after Tref seconds on the target trajectory derived by the gaze position deriving unit 170.

In addition, the second steering angle deriving unit 174 derives an index value on the basis of a function using the deviation G and the vehicle speed as parameters and derives a new index value by adding a coefficient K to the derived index value. In addition, the second steering angle deriving unit 174 derives the second steering angle on the basis of the derived new index value and the vehicle speed. It is noted that the second steering angle deriving unit 174 may restrict the control of the steering of the subject vehicle M in a case where the deviation G is equal to or greater than a predetermined value or in a case where the second steering angle is equal to or greater than a predetermined angle. Therefore, the second steering angle deriving unit 174 can suppress sudden turning of the subject vehicle M.

The combination unit 176 combines the first steering angle and the second steering angle to derive the steering angle to be output to the steering device 210. The combining unit 176 may change weights for the first steering angle and the second steering angle according to the vehicle speed. Specifically, in a case where the vehicle speed is low (for example, the vehicle speed is equal to or less than a first predetermined speed), the combining unit 176 sets the weight of the first steering angle so that the weight of the first steering angle is greater than the weight of the second steering angle. This is because the first steering angle derived on the basis of the circular arc has a small error at the low vehicle speed. On the other hand, at a high vehicle speed (equal to or greater than a second predetermined speed), it is possible to compensate for the deviation of the first steering angle by setting the weight of the second steering angle so that the weight of the second steering angle is greater than the weight of the first steering angle.

[Processing of Steering Angle Control Unit]

Here, as described above, the steering angle control unit 164 acquires the part of the information of the information on the target trajectory generated by the trajectory generation unit 146. In a case where the acquired information is information for controlling the subject vehicle M such that it is brought to a stopped state, the steering angle control unit 164 is not able to recognize a behavior (a destination) of the subject vehicle M after stopping. As a result, the steering angle control unit 164 may not be able to appropriately control the steering so that the behavior of the subject vehicle M at a time of a start after stopping may be smoothly performed.

On the other hand, the steering angle control unit 164 of the present embodiment derives the steering angle on the basis of a fitting trajectory FR and controls the steering on the basis of the derived steering angle. Therefore, it is possible to appropriately control the steering so that the behavior of the subject vehicle M when the subject vehicle M starts after the stop is smoothly performed. Hereinafter, this will be specifically described.

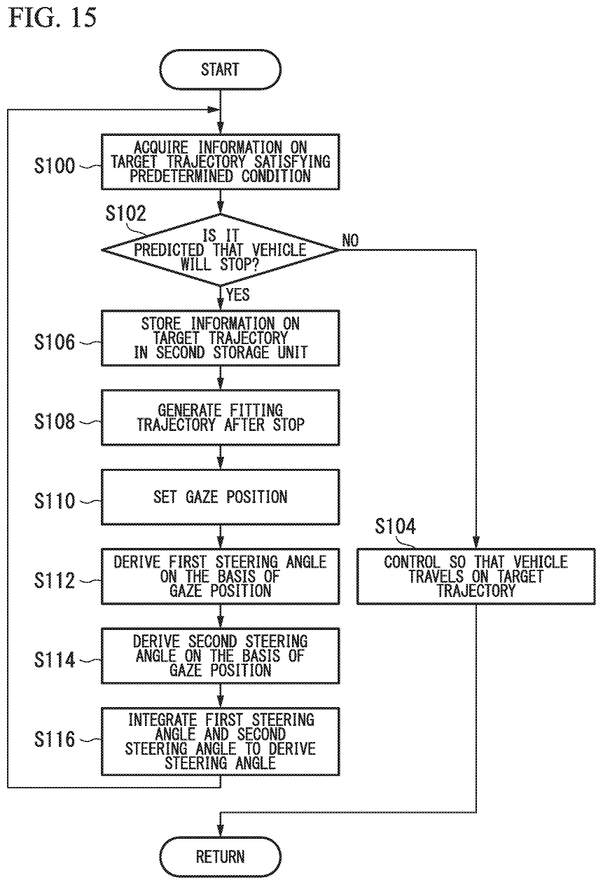

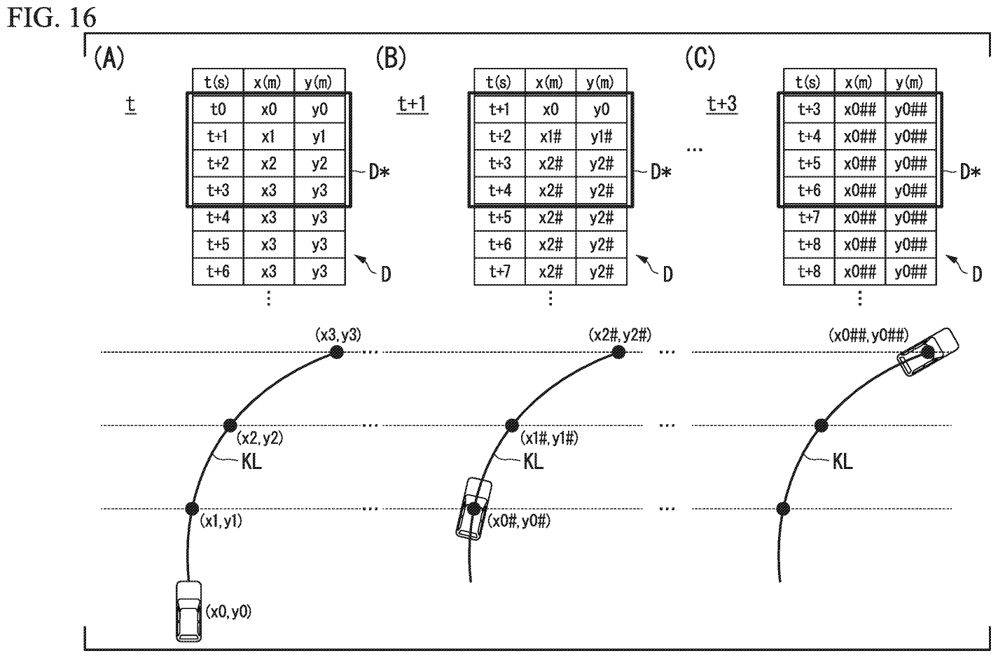

FIG. 15 is a flowchart illustrating a flow of the processing executed by the steering angle control unit 164. The present processing is executed for each processing period of the trajectory generation unit 146. Each processing of FIG. 15 will be described with reference to FIGS. 16 to 18.

First, the processing unit 165 acquires the target trajectory satisfying the predetermined condition from the automatic driving control unit 120 and stores the acquired information in the first storage unit 166 (step S100). Next, the determination unit 167 predicts whether or not the subject vehicle M will stop (determines whether or not the subject vehicle M is about to stop) on the basis of the acquired target trajectory (step S102). In a case where it is predicted that the subject vehicle M will not stop (it is determined that the subject vehicle M is not about to stop), the steering angle control unit 164 controls the steering so that the subject vehicle M travels on the target trajectory (step S104). For example, the first steering angle deriving unit 172, the second steering angle deriving unit 174, and the combining unit 176 control the steering angle by executing the processing described above.

FIG. 16 is a diagram for explaining the processing of the determination unit 167. An upper diagram of FIG. 16(A) shows information D on the target trajectory generated by the trajectory generation unit 146 and first storage information D* at the time t. The first storage information D* is information acquired by the first storage unit 166 and is part of information D on the target trajectory KL.

A lower diagram of FIG. 16(A) shows the position (x0, y0) of the subject vehicle M at the time t and the positions (x1, y1) to (x3, y3) of the subject vehicle M in the future.

An upper diagram of FIG. 16(B) shows the information D on the target trajectory generated by the trajectory generation unit 146 and first storage information D* at the time t+1. A lower diagram of FIG. 16(B) shows the position (x0#, y0#) of the subject vehicle M at the time t+1 and the positions (x1#, y1#) and (x2#, y2#) of the subject vehicle M in the future.

An upper diagram of FIG. 16(C) shows the information D on the target trajectory generated by the trajectory generation unit 146 and first storage information D* at the time t+3. A lower diagram of FIG. 16(C) shows the position (x0##, y0##) of the subject vehicle M at the time t+3. It is noted that illustration of the information D on the target trajectory, the first storage information D*, and the position of the subject vehicle M at the time t+2 is omitted.

For example, in a case where there is no change in the position of the subject vehicle M at successive times in the first storage information D*, the determination unit 167 predicts that the subject vehicle M will stop. In an example of FIG. 16, since the position of the subject vehicle M at the time t+3 and a time t+4 of the first storage information D* does not change at the time t+1, it is predicted that the subject vehicle M will stop. In this case, as shown in FIG. 16(C), the subject vehicle M stops at the time t+3. For example, the following processing is not executed before the subject vehicle M stops. It is noted that the determination unit 167 may predict that the subject vehicle M will stop in a case where there are three or more times at which the position of the subject vehicle M does not change.

Returning to the description of FIG. 15, in a case where it is predicted that the subject vehicle M will stop, the determination unit 167 stores the first storage information D* stored in the first storage unit 166 in the second storage unit 168 (step S106). Next, the application unit 169 generates the fitting trajectory FR using the first storage information D* stored in the second storage unit 168 (step S108). The fitting trajectory is a trajectory obtained by estimating the target trajectory of the subject vehicle M after the subject vehicle M starts in a state in which the subject vehicle M stops and the target trajectory is not obtained. It is noted that the fitting trajectory is considered as a trajectory extending from an end portion of the target trajectory and may be generated in a situation other than the above-described situation, for example, in a case where the target trajectory is not present in a progress direction of the subject vehicle M such as a case in which the subject vehicle M is behind the target trajectory, a case where the subject vehicle M has advanced from the target trajectory, or a case where the subject vehicle M is positioned at the end portion of the target trajectory.

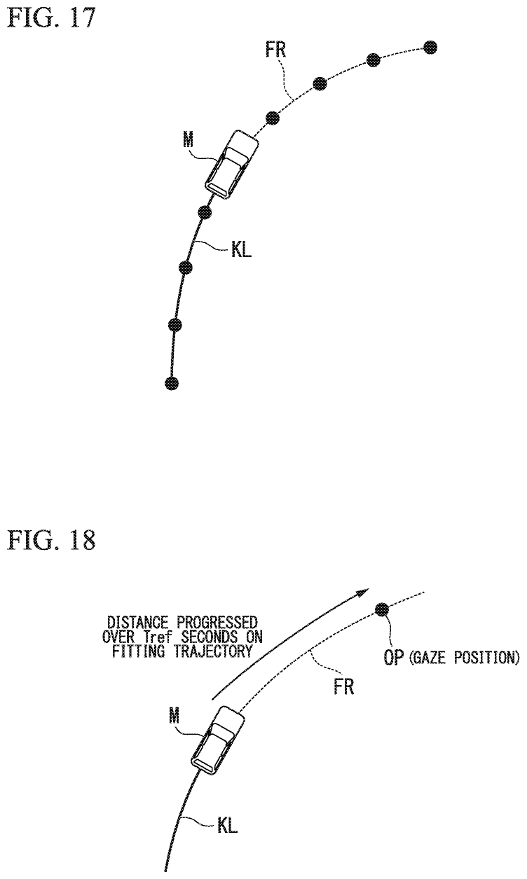

FIG. 17 is a diagram for explaining the processing of generating the fitting trajectory FR.

For example, the application unit 169 derives an nth degree function, an ellipse, a circle, and the like fit for the target trajectory KL stored in the second storage unit 168. For example, the application unit 169 derives a function or the like closest to the target trajectory KL stored in the second storage unit 168 by a method such as a least squares method while fixing n and changing the parameters of the nth degree function. The application unit 169 generates the fitting trajectory FR by applying the derived nth degree function also to the side in front of the subject vehicle M.

Next, the gaze position deriving unit 170 sets the gaze position OP on the fitting trajectory FR (step S110). Next, the first steering angle deriving unit 172 derives the first steering angle using the gaze position OP (step S112). FIG. 18 is a diagram for explaining the processing of deriving the gaze position. The gaze position deriving unit 170 derives a progress distance in which the subject vehicle M progresses on the fitting trajectory FR for Tref seconds on the basis of the vehicle speed of the subject vehicle M. The gaze position deriving unit 170 derives the position where the subject vehicle M is present after Tref seconds (or the position in a case where the subject vehicle M travels a predetermined distance, hereinafter the same) on the fitting trajectory FR as the gaze position OP.

Next, the second steering angle deriving unit 174 derives the second steering angle on the basis of the deviation (deviation) of the lateral direction between the subject vehicle M and the gaze position OP (step S114).

Next, the combining unit 176 integrates the first steering angle and the second steering angle to derive the steering angle to be used in the control (step S116). As a result, in a case where the subject vehicle M is about to stop, during the deceleration, the steering device 210 is controlled by the steering angle derived by reflecting the fitting trajectory FR. Therefore, the subject vehicle M can stop in a state in which a steering direction matches a direction estimated that the subject vehicle M progresses after the subject vehicle M starts. Therefore, the processing of the present flowchart is ended.

It is noted that the combining unit 176 may derive the steering angle by summing the first steering angle and the second steering angle or may derive the steering angle by giving the weights to the first steering angle and the second steering angle respectively and obtaining a weighted sum. In addition, in a case where the derived steering angle is greater than the predetermined angle, the combining unit 176 may limit the steering angle to being a steering angle equal to or less than the predetermined angle.

In addition, in the processing described above, the first steering angle deriving unit 172 derives the first steering angle and the second steering angle deriving unit 174 derives the second steering angle on the basis of the fitting trajectory. On the other hand, in a case where it is determined (predicted) that the subject vehicle M will stop after a predetermined time by the determination unit 167 and the steering angle control unit 164 acquires information on the target trajectory in front of the stop position of the subject vehicle M (in a case where the target trajectory is present), the first steering angle deriving unit 172 may derive the first steering angle and the second steering angle deriving unit 174 may derive the second steering angle on the basis of the acquired (existing) target trajectory. In this case, the combining unit 176 integrates the derived first steering angle and second steering angle to derive the steering angle to be used in the control on the basis of the target trajectory.

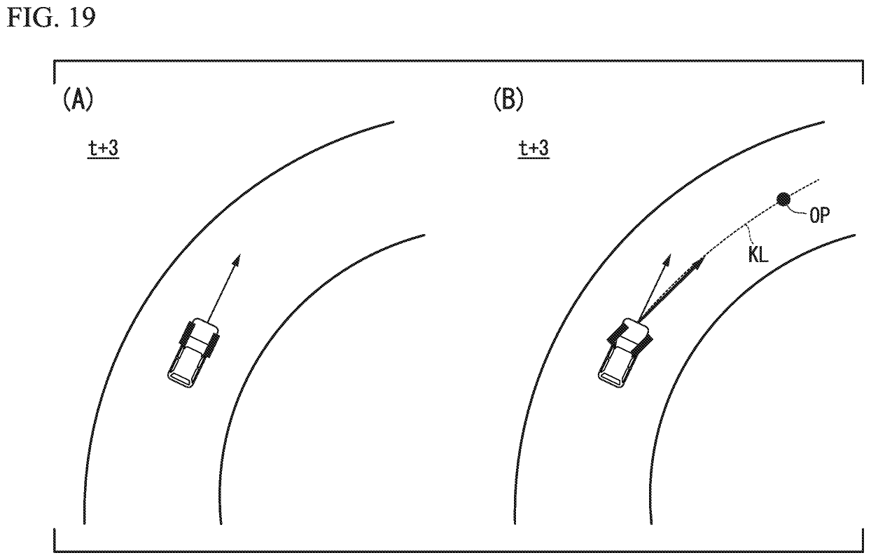

FIG. 19 is a diagram illustrating an example of an aspect in which the subject vehicle M is controlled by the processing of the present embodiment. For example, FIG. 19 is a diagram showing the state of the subject vehicle M at the time t+3 of FIG. 18 in detail. FIG. 19(a) shows the behavior of the subject vehicle M in a case where the present embodiment is not applied and FIG. 19(b) shows the behavior of the subject vehicle M in a case where the present embodiment is applied.

In a vehicle that acquires a target trajectory for a predetermined time in the future and performs steering control, there is a case where a steering component is lost from the target trajectory and becomes a trajectory for stopping the vehicle in a straight line at the time of the stop. The fact that the steering component is lost means that the steering angle is zero (neutral). As shown in FIG. 19(a), in a case where the vehicle restarts the traveling after the vehicle stops on a curve road, the traveling may be started in a state in which the steering angle is about zero in some cases. In this case, in the subject vehicle M, it is necessary to suddenly steer the subject vehicle M after the start in some cases.

On the other hand, in a case where the present embodiment is applied, the steering angle of the subject vehicle M is controlled by reflecting the fitting trajectory FR at the time of the stop. As a result, in a case where the traveling is restarted, originally, since it is estimated that the fitting trajectory FR also continuously maintains the steering angle in a case where the vehicle is traveling while maintaining a certain steering angle, there is a high likelihood that it will not be necessary to suddenly perform the steering after the start.

Therefore, the subject vehicle M can smoothly travel before and after the stop.

According to the first embodiment described above, in a case where it is predicted that the subject vehicle M will stop by the determination unit 167, the vehicle control system 100 generates the fitting trajectory after the subject vehicle M stops on the basis of the target trajectory before the subject vehicle M stops. In addition, the vehicle control system 100 derives the steering angle on the basis of the gaze position OP of the fitting trajectory FR and controls the subject vehicle M on the basis of the derived steering angle. As a result, it is possible to appropriately control the steering angle when the vehicle starts after the vehicle stops.

### Second Embodiment

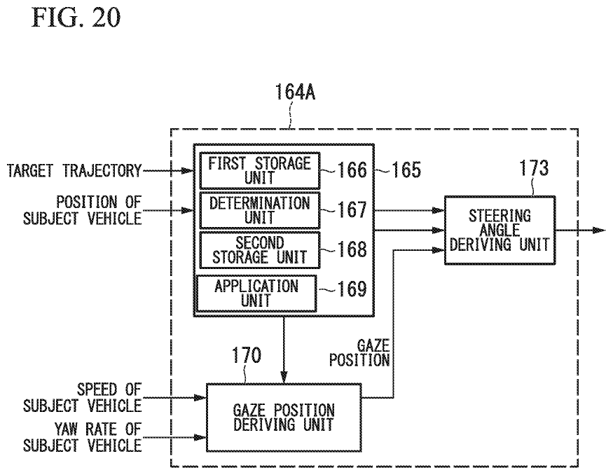

Hereinafter, the second embodiment will be described. FIG. 20 is a diagram illustrating an example of a function of a steering angle control unit 164A of the second embodiment. In the steering angle control unit 164A according to the second embodiment, the second steering angle deriving unit 174 and the combining unit 176 are omitted. The steering angle control unit 164A includes the processing unit 165, the gaze position deriving unit 170, and a steering angle deriving unit 173. The processing unit 165, the gaze position deriving unit 170, and the steering angle deriving unit 173 have the same functions as the processing unit 165, the gaze position deriving unit 170, and the first steering angle deriving unit 172 of the first embodiment, respectively. Hereinafter, differences from the first embodiment will be mainly described.

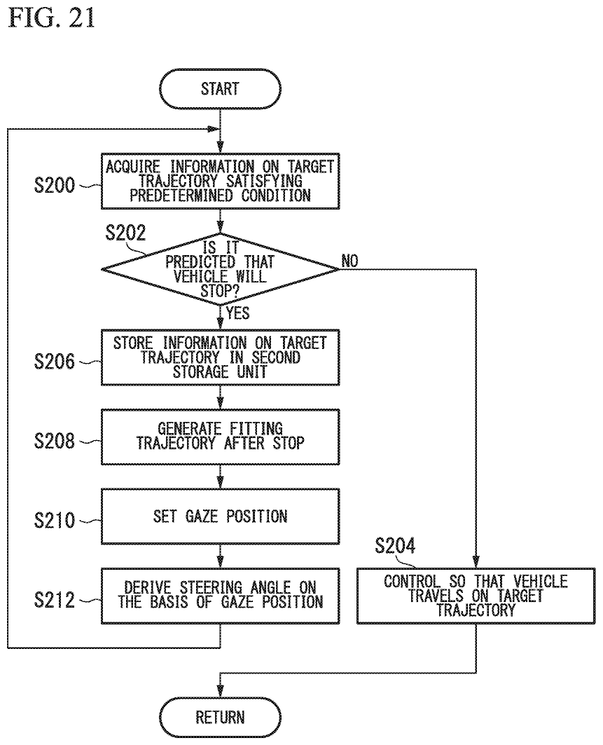

FIG. 21 is a flowchart illustrating a flow of processing executed by the steering angle control unit 164A. First, the processing unit 165 acquires the target trajectory satisfying the predetermined condition from the automatic driving control unit 120 and stores the acquired information in the first storage unit 166 (step S200). Next, the determination unit 167 predicts whether or not the subject vehicle M will stop (determines whether or not the subject vehicle M is about to stop) on the basis of the acquired target trajectory (step S202). In a case where it is predicted that the subject vehicle M will not stop (it is determined that the subject vehicle M is not about to stop), the steering angle control unit 164 controls the steering so that the subject vehicle M travels on the target trajectory (step S204).

In a case where it is predicted that the subject vehicle M will stop, the determination unit 167 stores the first storage information D* stored in the first storage unit 166 in the second storage unit 168 (step S206). Next, the application unit 169 generates the fitting trajectory FR using the first storage information D* stored in the second storage unit 168 (step S208).

Next, the gaze position deriving unit 170 sets the gaze position on the fitting trajectory FR (step S210). Next, the steering angle deriving unit 173 derives the steering angle using the gaze position (step S212). Therefore, the processing of the present flowchart is ended.

According to the second embodiment described above, the second steering angle deriving unit 174 is omitted. Therefore, it is possible to appropriately control the steering angle when the vehicle starts after the vehicle stops while reducing a processing load.

According to the embodiments described above, the vehicle control system 100 includes a trajectory generation unit configured to generate a target trajectory of a vehicle, a determination unit configured to determine whether or not the vehicle is about to stop on the basis of the target trajectory generated by the trajectory generation unit, and a post-stop target trajectory generation unit configured to generate a post-stop target trajectory after the vehicle stops on the basis of the target trajectory before the vehicle stops in a case where it is determined that the vehicle is about to stop by the determination unit. Therefore, it is possible to appropriately control the steering angle when the vehicle starts after the vehicle stops.

Although aspects for carrying out the present invention have been described above using the embodiments, the present invention is not limited to these embodiments at all, and various modifications and substitutions may be added without departing from the spirit of the present invention.

### REFERENCE SIGNS LIST

20 Viewfinder
30 Radar
40 Camera
DD Detection device
50 Navigation device
60 Vehicle sensor
62 Display device
100 Vehicle control system
110 Target lane determination unit
120 Automatic driving control unit
130 Automatic driving mode control unit
140 Subject vehicle position recognition unit
142 External space recognition unit
144 Action plan generation unit
146 Trajectory generation unit
146A Traveling aspect determination unit
146B Trajectory candidate generation unit
146C Evaluation⋅selection unit
148 Target trajectory setting unit
150 Switch control unit
160 Traveling control unit
162 Acceleration or deceleration control unit
164 Steering angle control unit
165 Processing unit
166 First storage unit
167 Determination unit
168 Second storage unit
169 Application unit
170 Gaze position deriving unit
172 First steering angle deriving unit
174 Second steering angle deriving unit
176 Combining unit
180 Storage unit
200 Traveling driving force output device
210 Steering device
220 Brake device
M Subject vehicle

What is claim is:

1. A vehicle control system comprising:
a trajectory generation unit configured to generate a target trajectory of a vehicle;
a determination unit configured to determine whether or not the vehicle is about to stop on the basis of the target trajectory generated by the trajectory generation unit; and
a post-stop target trajectory generation unit configured to generate a post-stop target trajectory after the vehicle stops on the basis of the target trajectory before the vehicle stops in a case where it is determined that the vehicle is about to stop by the determination unit.

2. The vehicle control system of claim 1, further comprising:
a traveling control unit configured to derive a steering angle of the vehicle in a state in which the vehicle stops on the basis of the post-stop target trajectory generated by the post-stop target trajectory generation unit and control a steering device on the basis of the derived steering angle.

3. The vehicle control system of claim 2, wherein the traveling control unit derives the steering angle of the vehicle at a time when the vehicle stops before the vehicle stops on the basis of the post-stop target trajectory generated by the post-stop target trajectory generation unit and controls the steering device on the basis of the derived steering angle.

4. The vehicle control system of claim 1, wherein the determination unit determines whether or not the vehicle is about to stop on the basis of part of information on the target trajectory of the vehicle generated by the trajectory generation unit.

5. The vehicle control system of claim 1, further comprising:
a first storage unit configured to accumulate information on the target trajectory of the vehicle generated by the trajectory generation unit and overwrite the target trajectory of the vehicle on the basis of the accumulated state; and
a second storage unit configured to store the information on the target trajectory,
wherein, in a case where the determination unit determines that the vehicle is about to stop, the determination unit stores part of the information on the target trajectory of the vehicle accumulated in the first storage unit into the second storage unit.

6. The vehicle control system of claim 5, wherein, in a case where it is determined that the vehicle is about to stop by the determination unit, the post-stop target trajectory generation unit generates the post-stop target trajectory after the vehicle stops on the basis of the information on the target trajectory stored in the second storage unit.

7. A vehicle control system comprising:
a first trajectory generation unit configured to generate a target trajectory of a vehicle as a position of the vehicle at each sampling time;
a determination unit configured to acquire the target trajectory of the vehicle generated by the first trajectory generation unit and determine whether or not the position of the vehicle is in an unchanged state for a predetermined time on the basis of the position of the vehicle at each sampling time included in the acquired target trajectory; and
a second trajectory generation unit configured to generate the target trajectory of the vehicle at a time after a position determined as the unchanged state on the basis of the position of the vehicle at a time before the position determined as the unchanged state in a case where it is determined that the position of the vehicle is in the unchanged state for the predetermined time by the determination unit.

8. A vehicle control method that causes an in-vehicle computer to:
generate a target trajectory of a vehicle;
determine whether or not the vehicle is about to stop on the basis of the generated target trajectory; and
generate a post-stop target trajectory after the vehicle stops on the basis of the target trajectory before the vehicle stops in a case where it is determined that the vehicle is about to stop.

9. A vehicle control program that causes an in-vehicle computer to:
generate a target trajectory of a vehicle;
determine whether or not the vehicle is about to stop on the basis of the generated target trajectory; and
generate a post-stop target trajectory after the vehicle stops on the basis of the target trajectory before the vehicle stops in a case where it is determined that the vehicle is about to stop.
